(19) United States
(12) Patent Application Publication
(10) Pub. No.: US 2014/0104830 A1
(43) Pub. Date: Apr. 17, 2014

(54) LIGHTING APPARATUS WITH A MOUNTING SYSTEM FOR LIGHTING ACCESSORIES

(71) Applicant: American DJ Supply, Inc., Los Angeles, CA (US)

(72) Inventor: Toby VELAZQUEZ, Yorba Linda, CA (US)

(73) Assignee: American DJ Supply, Inc., Los Angeles, CA (US)

(21) Appl. No.: 14/053,446

(22) Filed: Oct. 14, 2013

Related U.S. Application Data
(60) Provisional application No. 61/714,173, filed on Oct. 15, 2012.

(51) Int. Cl. F21V 17/00

(52) U.S. Cl. CPC F21V 17/002
USPC 362/232

(57) ABSTRACT

One embodiment provides a lighting apparatus comprising a lighting base including one or more lighting elements, and a control module for controlling the lighting elements. The lighting apparatus further comprises at least one removable lighting accessory for adjusting light emitted by the lighting elements, and a mounting system comprising at least one removable mounting member. Each mounting member is shaped to engage with and securely mount a lighting accessory to the lighting base.

### CROSS REFERENCE TO RELATED APPLICATIONS

This application claims priority from U.S. Provisional Patent Application Ser. No. 61/714,173, filed on Oct. 15, 2012, incorporated herein by reference.

### BACKGROUND

The present invention relates generally to a lighting apparatus, and in particular, to a lighting apparatus with a mounting system for lighting accessories.

Lighting apparatuses are used for illuminating both indoor and outdoor environments. Proper illumination is vital when filming movies, television shows, shooting videos, taking photographs, lighting live stage performances, and other similar activities.

### BRIEF SUMMARY

One embodiment provides a lighting apparatus comprising a lighting base including one or more lighting elements, and a control module for controlling the lighting elements. The lighting apparatus further comprises at least one removable lighting accessory for adjusting light emitted by the lighting elements, and a mounting system comprising at least one removable mounting member. Each mounting member is shaped to engage with and securely mount a lighting accessory to the lighting base.

Another embodiment provides a lighting system comprising multiple lighting apparatuses and a controller for providing data control signals to at least one lighting apparatus. Each lighting apparatus comprises a lighting base including one or more lighting elements, and a control module for controlling the lighting elements. Each lighting apparatus further comprises a mounting system comprising at least one removable lighting accessory for adjusting light emitted by lighting elements of the lighting apparatus, and at least one removable mounting member. Each mounting member is shaped to engage with and securely mount a lighting accessory to a lighting base of a lighting apparatus.

One embodiment provides a method comprising mounting at least one removable lighting accessory to a lighting apparatus via a mounting system comprising at least one mounting member, and adjusting light emitted by lighting elements of the lighting apparatus via the lighting accessory. Each mounting member is shaped to engage with and securely mount a lighting accessory to the lighting apparatus.

These and other features, aspects and advantages of the present invention will become understood with reference to the following description, appended claims and accompanying figures.

### BRIEF DESCRIPTION OF THE SEVERAL VIEWS OF THE DRAWINGS

FIG. 1 illustrates a top view of a lighting apparatus, in accordance with an embodiment of the invention.

FIG. 2 illustrates a top perspective view of an example mounting member, in accordance with an embodiment of the invention.

FIG. 3 illustrates a bottom perspective view of an example mounting member, in accordance with an embodiment of the invention.

FIG. 4A illustrates a side view of an example mounting member, in accordance with an embodiment of the invention.

FIG. 4B illustrates a top view of mechanical guides of an example mounting member, in accordance with an embodiment of the invention.

FIG. 4C illustrates a bottom view of an example mounting member, in accordance with an embodiment of the invention.

FIG. 4D illustrates a bottom perspective view of an example mounting member, in accordance with an embodiment of the invention.

FIG. 4E illustrates mechanical guides of an example mounting member, in accordance with an embodiment of the invention.

FIG. 4F illustrates a top view of an example mounting member including a removable lens module, in accordance with an embodiment of the invention.

FIG. 5 illustrates an example removable shade module, in accordance with an embodiment of the invention.

FIG. 6 illustrates another example removable shade module, in accordance with an embodiment of the invention.

FIG. 7 illustrates a bottom view of an example removable shade module, in accordance with an embodiment of the invention.

FIG. 8 illustrates an example mounting member interlocked with a removable shade module that is disposed within the mounting member, in accordance with an embodiment of the invention.

FIG. 9 illustrates a bottom perspective view of another example removable shade module, in accordance with an embodiment of the invention.

FIG. 10 illustrates a mounting member disposed within a removable shade module, in accordance with an embodiment of the invention.

FIG. 11 illustrates rotating a removable shade module to interlock the removable shade module with an outer wall of the mounting member, in accordance with an embodiment of the invention.

FIG. 12 illustrates a top panel of a lighting apparatus, in accordance with an embodiment of the invention, in accordance with an embodiment of the invention.

FIG. 13 illustrates a removable shade module with a substantially cylindrical body, in accordance with an embodiment of the invention.

FIG. 14 illustrates a removable shade module with a substantially spherical body, in accordance with an embodiment of the invention.

FIG. 15 illustrates a front perspective view of a lighting apparatus, in accordance with an embodiment of the invention.

FIG. 16 illustrates a rear perspective view of a lighting apparatus, in accordance with an embodiment of the invention.

FIG. 17 is a block diagram illustrating a control module of a lighting apparatus, in accordance with an embodiment of the invention.

FIG. 18 is a block diagram illustrating multiple lighting apparatuses arranged in a parallel lighting circuit, in accordance with an embodiment of the invention.

FIG. 19 is a block diagram illustrating multiple lighting apparatuses linked in a daisy-chain lighting circuit, in accordance with an embodiment of the invention.

### DETAILED DESCRIPTION

The present invention relates generally to a lighting apparatus, and in particular, to a lighting apparatus with a mounting system for lighting accessories. One embodiment provides a lighting apparatus comprising a lighting base including one or more lighting elements, and a control module for controlling the lighting elements. The lighting apparatus further comprises a mounting system including at least one removable lighting accessory for adjusting light emitted by the lighting elements, and at least one removable mounting member. Each mounting member is shaped to engage with and securely mount a lighting accessory to the lighting base.

In one embodiment, a lighting accessory comprises a removable lens module for adjusting a beam angle of light emitted by the lighting elements. In another embodiment, a lighting accessory comprises a removable shade module for covering the lighting elements, thereby diffusing light emitted by the lighting elements.

In one embodiment, each mounting member comprises a recess shaped for receiving a lighting accessory inserted into the recess, and a set of mechanical guides shaped to engage and mate with a lighting accessory inserted into the recess. In one embodiment, the set of mechanical guides comprises one or more locking portions for engaging and mating with a mating portion of a lighting accessory.

In one embodiment, each mounting member comprises a set of mechanical guides shaped to interlock with a lighting accessory when the mounting member is inserted into the lighting accessory. In one embodiment, the set of mechanical guides comprises a plurality of axially extending serrations for engaging and mating with a mating portion of a lighting accessory.

In one embodiment, each mounting member comprises a lens retaining ring holder for retaining a removable lens module.

In one embodiment, each mounting member comprises one or more magnetic fasteners for magnetically coupling the mounting member to the lighting base.

In one embodiment, the lighting apparatus further comprises a control module including a plurality of drivers. The drivers include at least one lighting driver for selectively controlling lighting effects of at least one of lighting element.

Another embodiment provides a lighting system comprising multiple lighting apparatuses and a controller for providing data control signals to at least one lighting apparatus. Each lighting apparatus comprises a lighting base including one or more lighting elements, and a control module for controlling the lighting elements. Each lighting apparatus further comprises a mounting system comprising at least one removable lighting accessory for adjusting light emitted by lighting elements of the lighting apparatus, and at least one removable mounting member. Each mounting member is shaped to engage with and securely mount a lighting accessory to a lighting base of a lighting apparatus.

One embodiment provides a method comprising mounting at least one removable lighting accessory to a lighting apparatus via a mounting system comprising at least one mounting member, and adjusting light emitted by lighting elements of the lighting apparatus via the lighting accessory. Each mounting member is shaped to engage with and securely mount a lighting accessory to the lighting apparatus.

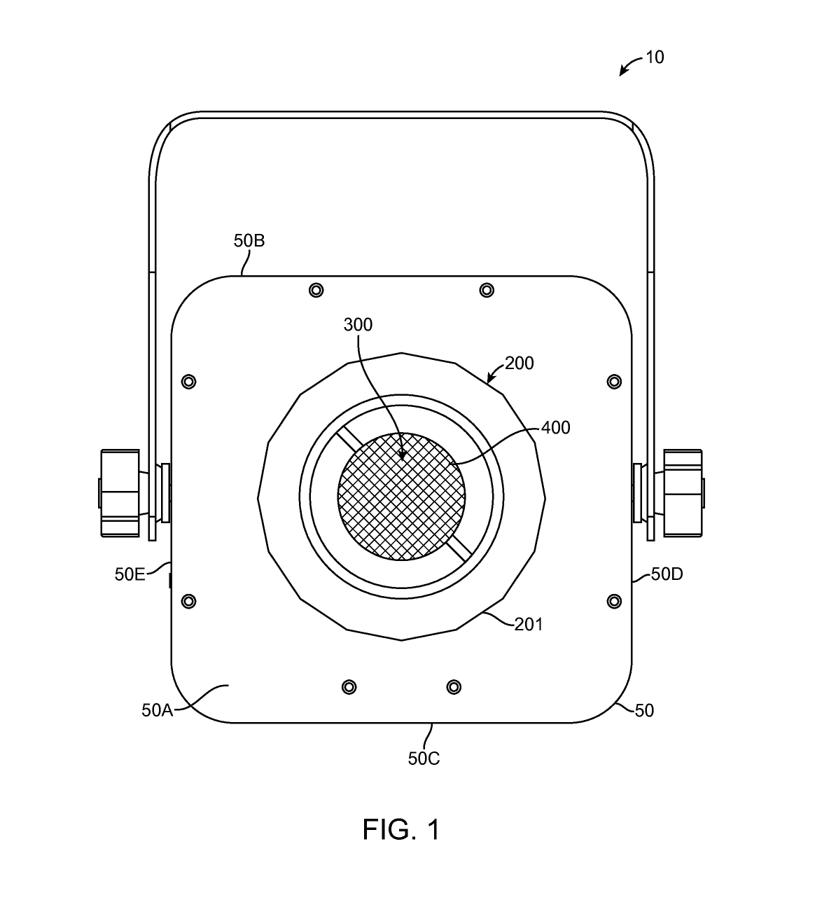

FIG. 1 illustrates a top view of a lighting apparatus 10, in accordance with an embodiment of the invention. The lighting apparatus 10 comprises a lighting base 50 and a mounting system 200 for mounting one or more removable lighting accessories 300 to the lighting base 50.

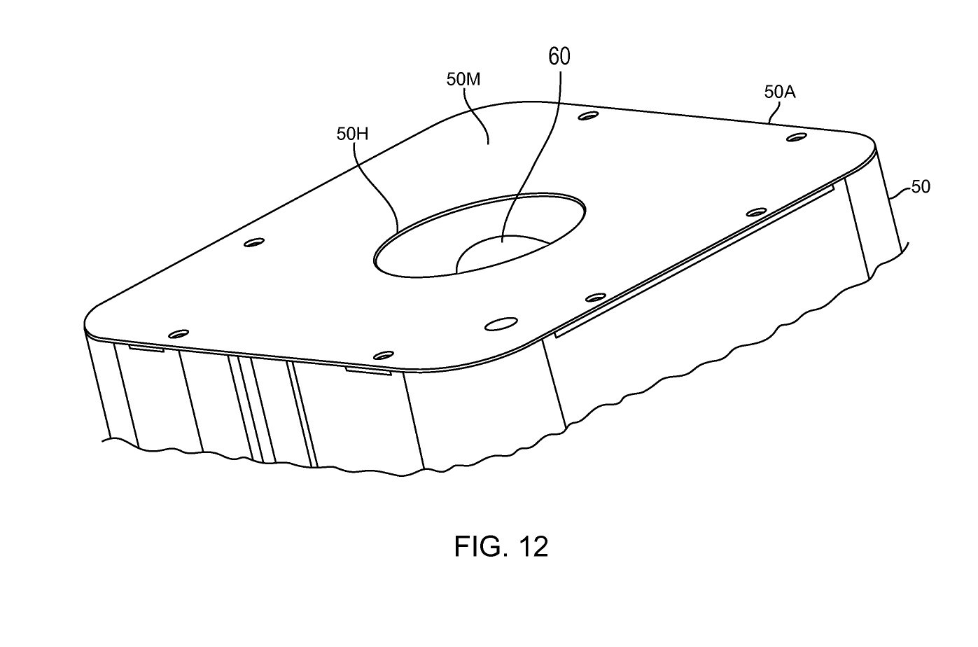

The shape of the lighting base 50 may vary. In one embodiment, the lighting base 50 is substantially square-shaped. The lighting base 50 maintains (i.e., houses) one or more lighting elements 60 (FIG. 12). Each lighting element 60 may comprise, for example, one or more semiconductor light emitting diodes (LEDs), organic LEDs, light bulbs, lasers, or liquid crystal display (LCD) panels.

The lighting base 50 has a top panel 50A that includes an aperture (i.e., hole) 50H (FIG. 12). The lighting elements 60 are disposed below the aperture 50H, such that light from the lighting elements 60 passes through the aperture 50H. As shown in FIG. 1, the lighting base 50 further includes a plurality of side walls, such as a first side wall 50B, second side wall 50C, a third side wall 50D, and a fourth side wall 50E.

The mounting system 200 comprises at least one mounting member 201 and at least one removable lighting accessory 300. The shape of each mounting member 201 may vary. As described in detail later herein, each mounting member 201 may be used to mount a removable lighting accessory 300 onto the top panel 50A of the lighting base 50. The shape of each removable lighting accessory 300 may vary. In one embodiment, the mounting system 200 includes one or more of the following removable lighting accessories 300: at least one removable lens module 400, and at least one removable shade module 500 (FIGS. 5-6).

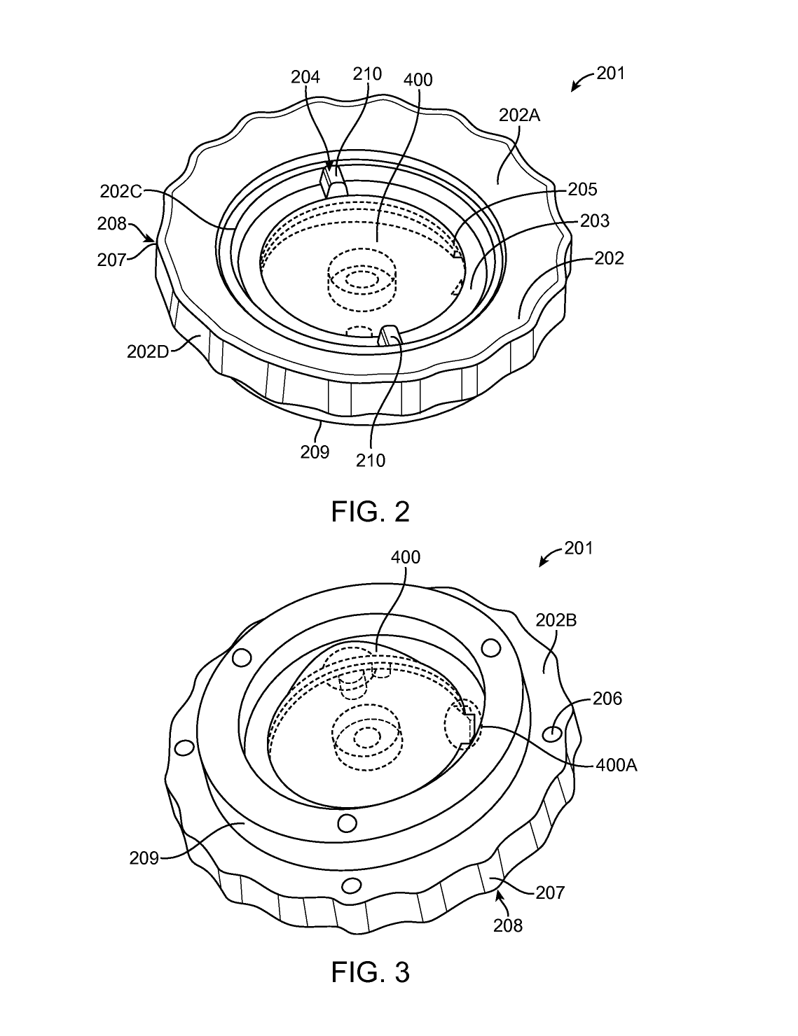

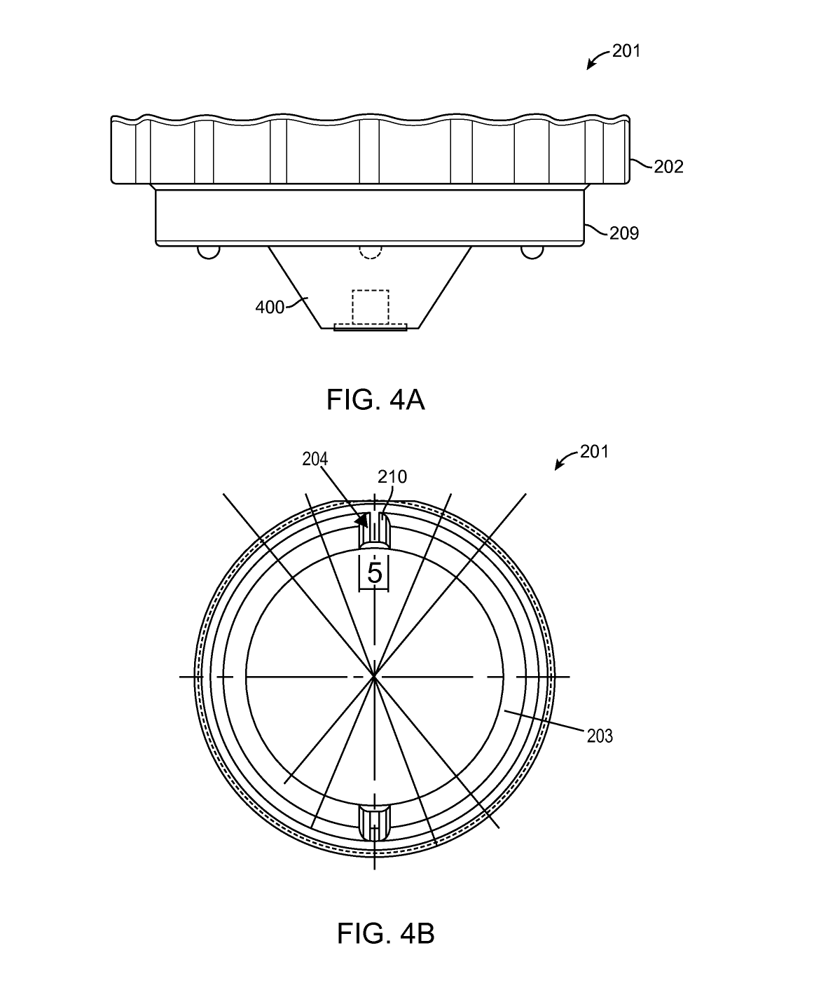

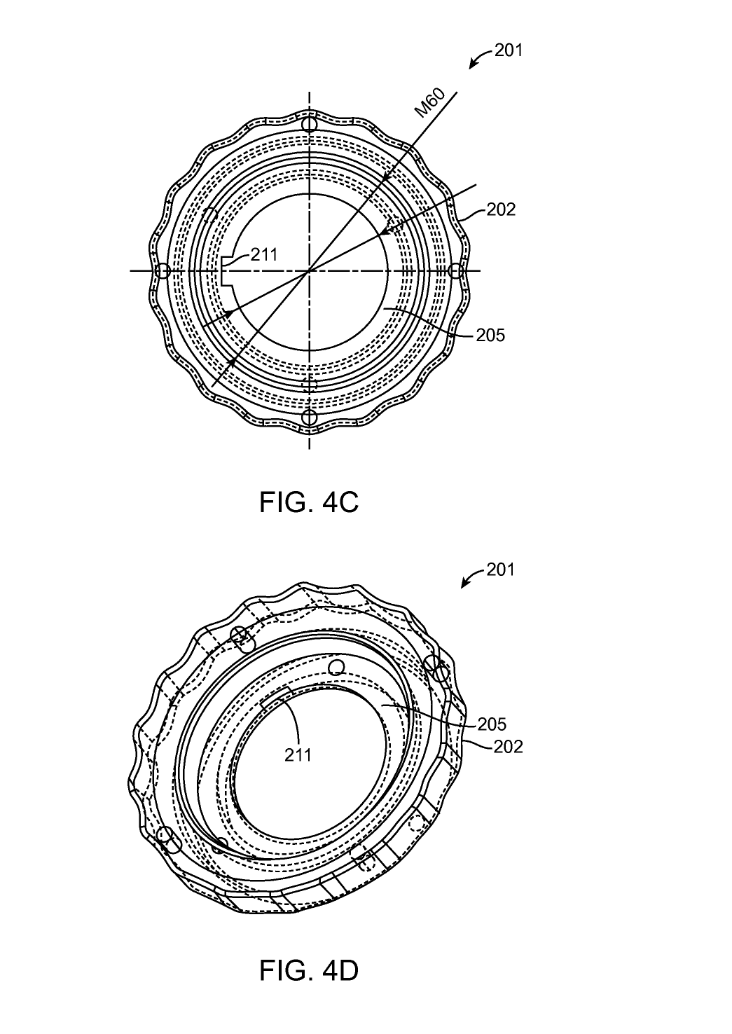

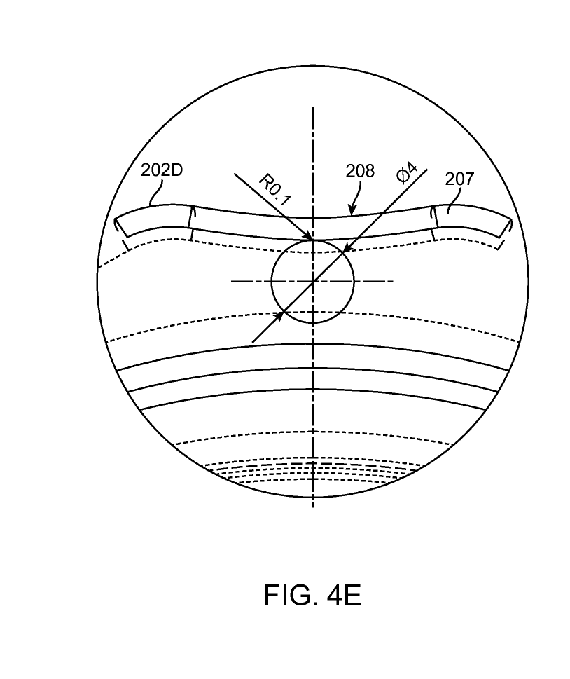

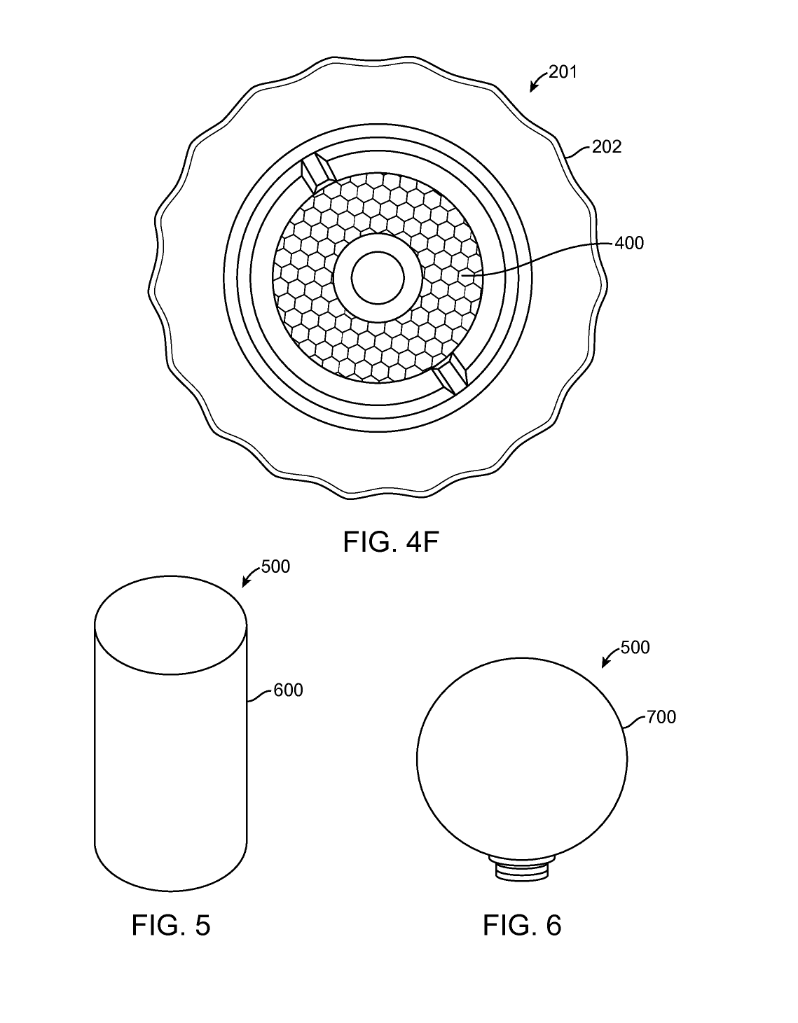

FIGS. 2-4F illustrate different views of an example mounting member 201 including a removable lens module 400, in accordance with an embodiment of the invention. Specifically, FIG. 2 illustrates a top perspective view of the mounting member 201. FIG. 3 illustrates a bottom perspective view of the mounting member 201. FIG. 4A illustrates a side view of the mounting member 201. As stated above, the shape of each mounting member 201 may vary. As shown in FIGS. 2-4A, in one embodiment, a mounting member 201 has a substantially barrel-shaped body 202 including a top side 202A and a bottom side 202B. The body 202 further includes a protruding portion 209 extending rearwardly from the bottom side 202B of the body 202.

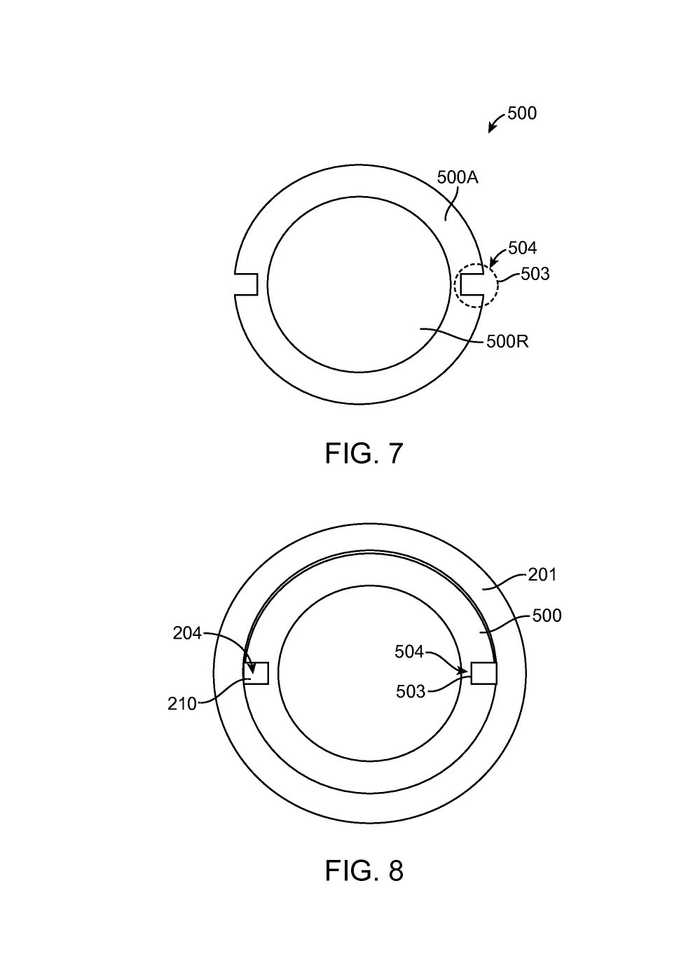

Each mounting member 201 is adapted to engage and mate with at least one removable lighting accessory 300. For example, as shown in FIG. 2, the body 202 of the mounting member 201 further includes a recess 203. The recess 203 is shaped for receiving a removable lighting accessory 300 inserted into the recess 203 via the top side 202A of the mounting member 201. Also shown in FIG. 2, an inner wall 202C of the body 202 has mechanical guides 204 for engaging and mating with the lighting accessory 300 inserted into the recess 203. In one embodiment, the mechanical guides 204 comprise one or more locking portions 210. As described in detail later herein, the locking portions 210 are adapted to engage and mate with a mating portion 504 (FIG. 7) of a removable lighting accessory 300 inserted into the recess 203.

The mounting member 201 further comprises a lens retaining ring holder 205 disposed in between the recess 203 and the protruding portion 209. The ring holder 205 is used retain a removable lens module 400, as shown in FIGS. 2-4A. In one embodiment, a lens module 400 may be used to change the beam angle of light emitted by the lighting elements 60 of the lighting apparatus 10. The ring holder 205 includes at least one notch 211 (FIG. 4C) that is adapted to engage and mate with a locking portion 400A (FIG. 3) of a removable lens module 400.

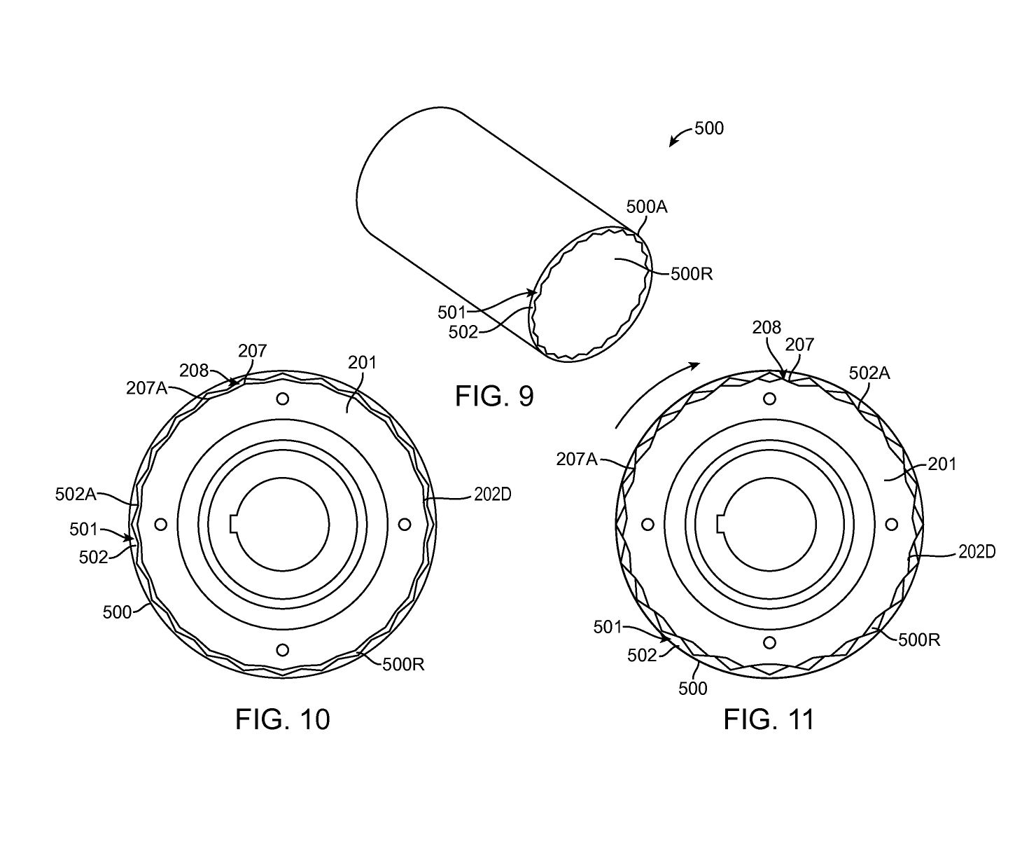

An outer wall 202D of the body 202 may also be used to engage and mate with a removable lighting accessory 300. As shown in FIGS. 2-3, the outer wall 202D has mechanical guides 208 for engaging and mating with a removable lighting accessory 300. In one embodiment, the mechanical guides 208 may comprise a plurality of axially extending serrations (i.e., splines) 207. As described in detail later herein, the serrations 207 may engage and mate with a mating portion 501 (FIG. 9) of a removable lighting accessory 300.

The mounting member 201 further comprises magnetic fasteners 206 that are distributed evenly on the bottom side 202B of the body 202. The magnetic fasteners 206 magnetically couple the bottom side 202B to the top panel 50A of the lighting base 50, thereby securing the mounting member 201 to the lighting base 50.

FIG. 4B illustrates a top view of mechanical guides 204 of an example mounting member 201, in accordance with an embodiment of the invention. In one embodiment, the mechanical guides 204 comprise one or more locking portions 210. Each locking portion 210 is adapted to engage and mate with a mating portion 504 (FIG. 7) of a removable lighting accessory 300 inserted into the recess 203 of the mounting member 201.

FIGS. 4C-4D illustrate different views of an example mounting member 201 without a removable lens module 400, in accordance with an embodiment of the invention. Specifically, FIG. 4C illustrates a bottom view of the mounting member 201. FIG. 4D illustrates a bottom perspective view of the mounting member 201. As stated above, the ring holder 205 of the mounting member 201 includes at least one notch 211 adapted to engage and mate with a locking portion 400A (FIG. 3) of a removable lens module 400.

FIG. 4E illustrates mechanical guides 206 of an example mounting member 201, in accordance with an embodiment of the invention. In one embodiment, the mechanical guides 208 comprise a plurality of axially extending serrations (i.e., splines) 207. Each serration 207 is adapted to engage and mate with a mating portion 501 (FIG. 9) of a removable lighting accessory 300.

FIG. 4F illustrates a top view of an example mounting member 201 including a removable lens module 400, in accordance with an embodiment of the invention.

In one embodiment, the mechanical guides 204, 208 of each mounting member 201 may further include additional fasteners like screws, snaps, or treads that further mate the mounting member 201 with a removable lighting accessory 300.

FIGS. 5-6 illustrate different example removable shade modules 500, in accordance with an embodiment of the invention. A removable shade module 500 is an example removable lighting accessory 300. As stated above, the shape of each removable shade module 500 may vary. For example, a removable shade module 500 may have a substantially cylindrical body 600, as shown in FIG. 5. As another example, a removable shade module 500 may have a substantially spherical body 700, as shown in FIG. 6.

FIG. 7 illustrates a bottom view of an example removable shade module 500, in accordance with an embodiment of the invention. The removable shade module 500 has a bottom side 500A including an opening 500R. The removable shade module 500 further comprises at least one mating portion 504 disposed at the bottom side 500A. Each mating portion 504 is adapted to engage and mate with a mounting member 201. In one embodiment, as shown in FIG. 7, each mating portion 504 comprises at least one groove portion 503.

The removable shade module 500 may be mounted onto the top panel 50A of the lighting base 50 by inserting the removable shade module 500 into the recess 203 of a mounting member 201, and securing the mounting member 201 (e.g., via the magnetic fasteners 206 of the mounting member 201) to the lighting base 50. Before inserting the removable shade module 500 into the recess 203 of a mounting member 201, each groove portion 503 of the removable shade module 500 is aligned with a corresponding locking portion 210 of the mounting member 201. Each groove portion 503 removably engages and interlocks with a corresponding locking portion 210 as the removable shade module 500 is inserted into the recess 203 of the mounting member 201. As such, the locking portions 210 and the groove portions 503 facilitate fitting, and maintaining in place, the removable shade module 500 within the recess 203 of the mounting member 201.

FIG. 8 illustrates an example mounting member 201 interlocked with a removable shade module 300 that is disposed within the mounting member 201, in accordance with an embodiment of the invention. Each groove portion 503 of the removable shade module 500 removably engages and interlocks with a corresponding locking portion 210 of the mounting member 201 as the removable shade module 500 is inserted into the recess 203 of the mounting member 201.

FIG. 9 illustrates a bottom perspective view of another example removable shade module 500, in accordance with an embodiment of the invention. In another embodiment, a removable shade module 500 is mounted onto the top panel 50A of the lighting base 50 by interlocking a bottom side 500A of the shade module 500 with the outer wall 202D of a mounting member 201. Specifically, the removable shade module 500 comprises a mating portion 501 disposed at the bottom side 500A of the shade module 500. The mating portion 501 is adapted to engage and mate with a mounting member 201 of the mounting system 200.

As shown in FIG. 9, in one embodiment, the mating portion 501 comprises internal teeth 502. The teeth 502 may engage and mate with the serrations 207 of a mounting member 201 to interlock the removable shade module 500 with the outer wall 202D of the mounting member 201.

FIGS. 10-11 illustrate the sequence of interlocking a removable shade module 500 with an outer wall 202D of a mounting member 201, in accordance with an embodiment of the invention. Specifically, FIG. 10 illustrates a mounting member 201 disposed within a removable shade module 500. FIG. 11 illustrates rotating the removable shade module 500 to interlock the removable shade module 500 with an outer wall 202D of the mounting member 201. The mounting member 201 is inserted into the removable shade module 500 via an opening 500R of the removable shade module 500. To engage and mate the mating portion 501 of the removable shade module 500 with the mechanical guides 208 disposed on the outer wall 202D of the mounting member 201, the removable shade module 500 is rotated in a first direction (e.g., in a clockwise direction), as shown in FIG. 11.

The shade module 500 is rotated until an edge 207A of each serration 207 comes in direct contact with a stop portion 502A of the teeth 502. Direct contact between the mating portion 501 and the mechanical guides 208 interlocks the mounting member 201 within the shade module 500, thereby restricting the shade module 500 from rotating further in the first direction. Rotating the shade module 500 in a second direction opposite of the first direction (e.g., counterclockwise) unlocks the mounting member 201 from the shade module 500.

FIG. 12 illustrates a top panel 50A of a lighting apparatus 10, in accordance with an embodiment of the invention. The aperture 50H of the top panel 50A is shaped for receiving the protruding portion 209 of a mounting member 201, such that the mounting member 201 is positioned above the aperture 50H of the top panel 50A.

In one embodiment, the top panel 50A of the lighting base 50 further comprises a metallic surface 50M for magnetically attracting the magnetic fasteners 206 of the mounting member 201, thereby magnetically coupling the mounting member 201 to the lighting base 50.

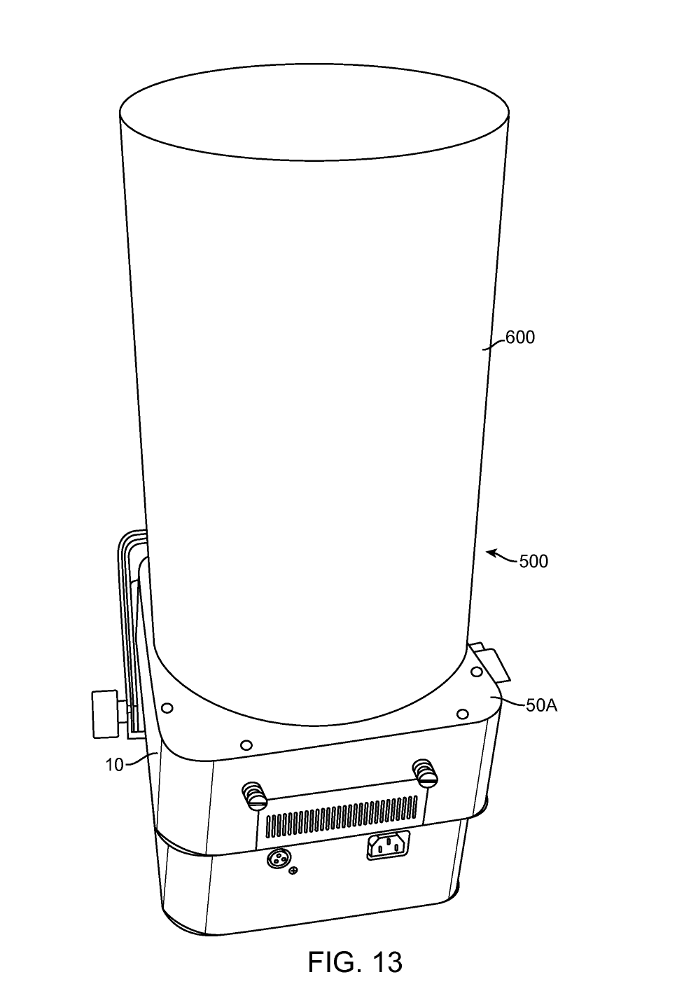

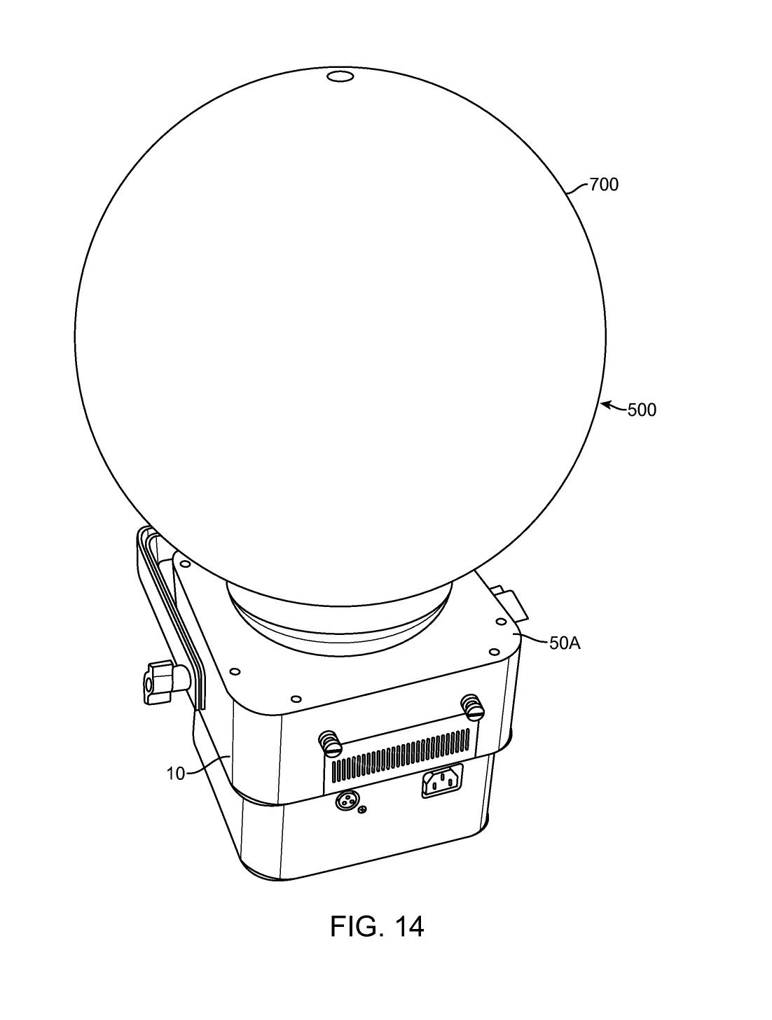

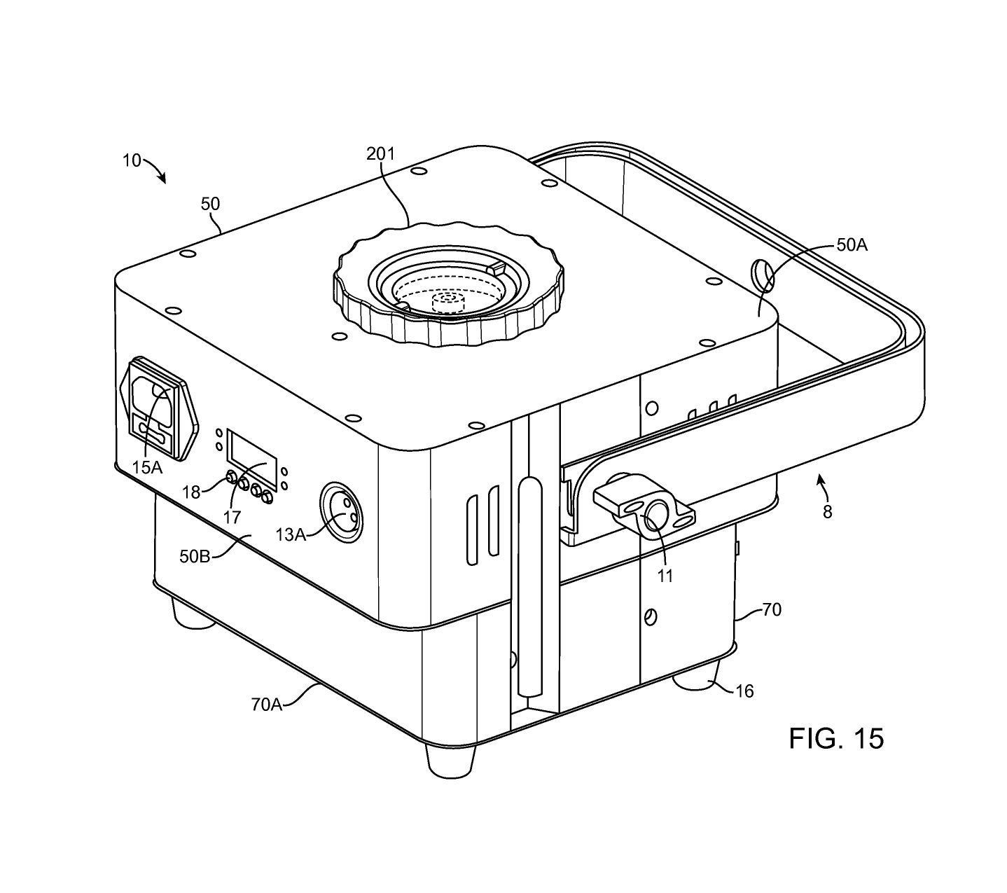

FIGS. 13-14 illustrate different removable shade modules 500 mounted onto a lighting apparatus 10, in accordance with an embodiment of the invention. Specifically, FIG. 13 illustrates a removable shade module 500 with a substantially cylindrical body 600. FIG. 14 illustrates a removable shade module 500 with a substantially spherical body 700. As stated above, a mounting member 201 is used to mount a removable shade module 500 onto the top panel 50A of the lighting apparatus 10. The mounting member 201 is positioned above the aperture 50H of the top panel 50A, such that light emitted from the lighting elements 60 disposed within the lighting base 50 passes through the removable shade module 500.

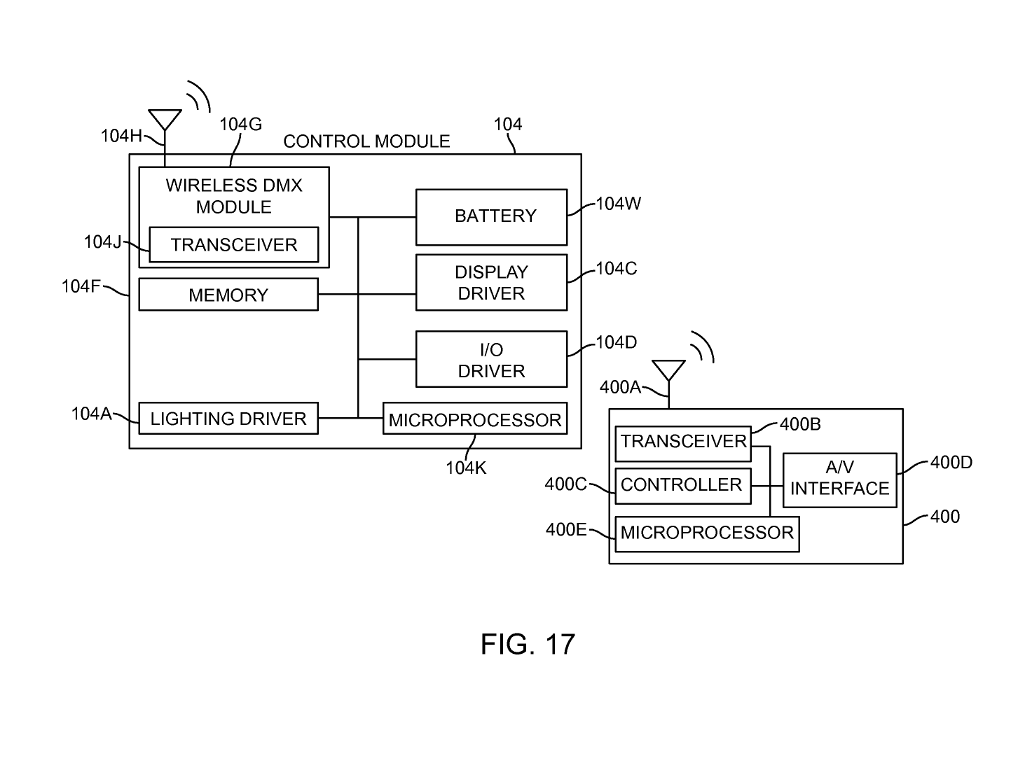

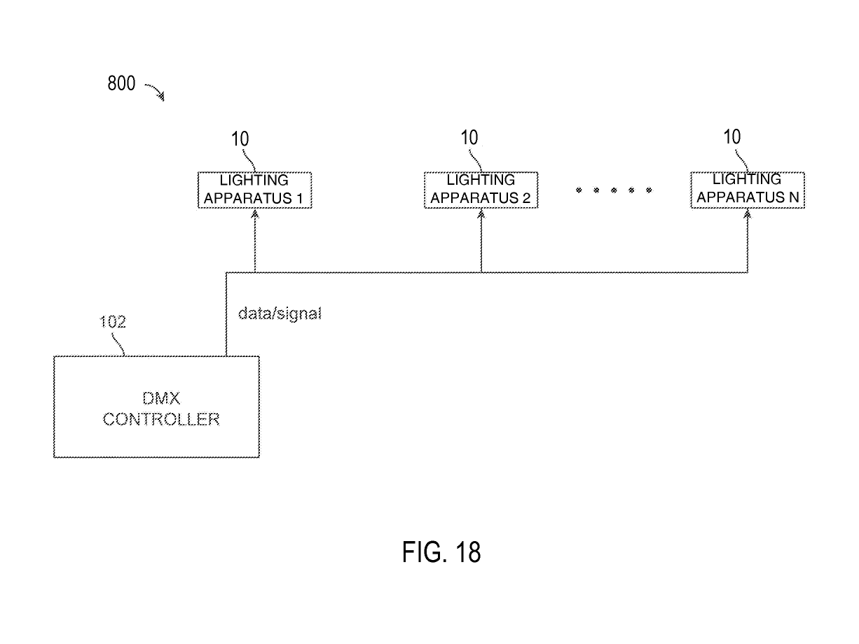

FIG. 15 illustrates a front perspective view of a lighting apparatus 10, in accordance with an embodiment of the invention. The lighting apparatus 10 may be powered by an on-board battery source 104W (FIG. 17) or an external power supply source (e.g., a power outlet, another lighting apparatus 10). In one embodiment, the first side wall 50B comprises a power input socket 15A for receiving power from an external power supply source (e.g., a power outlet, another lighting apparatus 10), and a data input connector 13A for receiving data control signals.

In one embodiment, the data input connector 13A is a 3-pin Digital Multiplex (DMX) input connector. In another embodiment, the data input connector 13A is a 5-pin DMX input connector. The data input connector 13A may receive DMX data instructions from a DMX controller 102 (FIG. 18) or another lighting apparatus 10.

The first side wall 50B further comprises an LCD menu control panel 17 and multiple manual control buttons 18. An operator may utilize the LCD menu control panel 17 and the manual control buttons 18 to display and control the lighting effect functions of the lighting apparatus 10, such as, for example, dimming, strobing, selective activation, pulsation, color temperature, and so on.

In one embodiment, the lighting apparatus 10 further comprises a support base 70 extending rearwardly from the lighting base 50. The support base 70 has a bottom side wall 70A comprising support members 16 (e.g., built-in feet). The support members 16 are distributed evenly on the bottom side wall 70A to stabilize and support the lighting apparatus 10 when the lighting apparatus 10 is set upright on a supporting surface (e.g., ground, a table).

In one embodiment, the lighting apparatus 10 further comprises a detachable dual mounting bracket 8 (e.g., double yoke) for mounting the lighting apparatus 10 to a floor stand or a wall, or hanging the lighting apparatus 10 in a lighting grid or a truss. Multiple rotatable knobs 11 secure the mounting bracket 8 to side walls of the lighting base 50.

The mounting bracket 8 may pivot by rotating each knob 11. Rotating a knob 11 in a first direction (e.g., clockwise) decreases the rotary movement of the knob 11 until the knob 11 is prevented from rotating further, thereby locking the orientation of the mounting bracket 8. Rotating a knob 11 in a second direction (e.g., counter-clockwise) increases the rotary movement of the knob 11 until the knob 11 is unscrewed from lighting base 50. The mounting bracket 8 is detached from the lighting apparatus 10 when each knob 11 securing the mounting bracket 8 to the lighting base 50 is unscrewed from the lighting base 50.

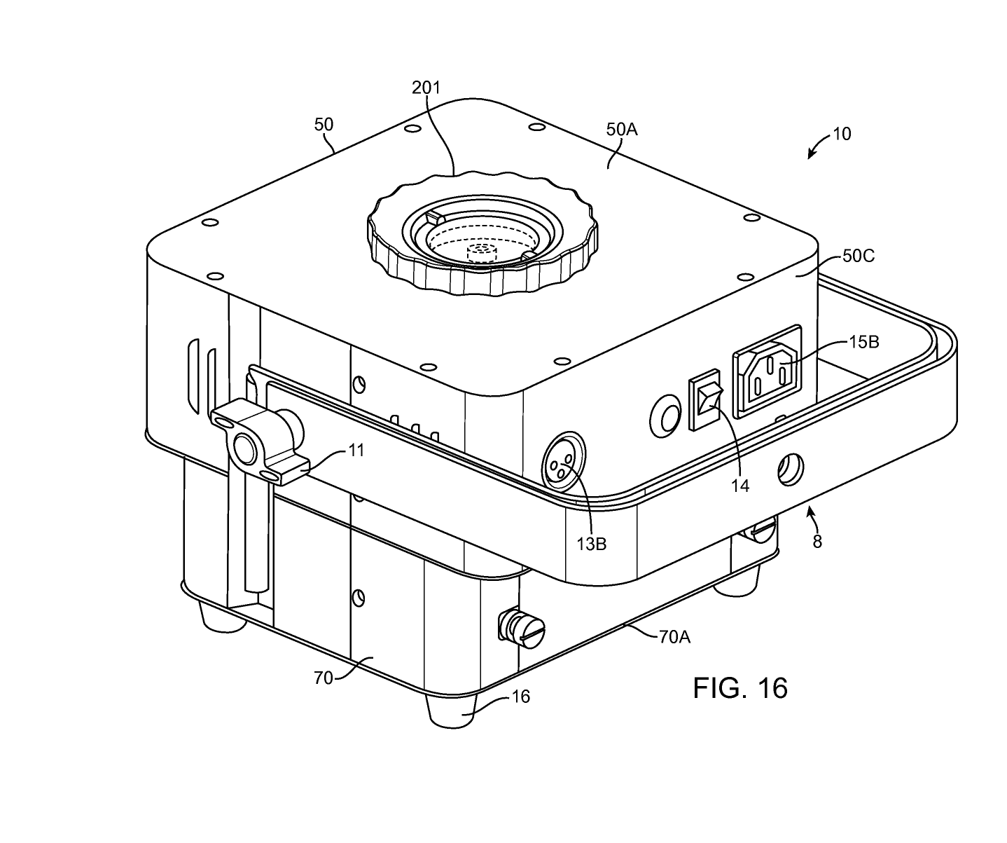

FIG. 16 illustrates a rear perspective view of a lighting apparatus 10, in accordance with an embodiment of the invention. The second side wall 50C of the lighting base 50 is substantially parallel to the first side wall 50B. In one embodiment, the second side wall 50C comprises a power output socket 15B for transmitting power to another lighting apparatus 10, and a data output connector 13B for transmitting data control signals.

In one embodiment, the data output connector 13B is a 3-pin DMX output connector. In another embodiment, the data output connector 13B is a 5-pin DMX output connector. The data output connector 13B may be used to transmit an outgoing DMX master/slave signal to another lighting apparatus 10.

The second side wall 50C further comprises a power button 14. The power button 14 is movable between an ON position and an OFF position. The lighting apparatus 10 is powered on when the power button 14 is in the ON position. The lighting apparatus 10 is powered off when the power button 14 is in the OFF position.

FIG. 17 is a block diagram illustrating a control module 104 of a lighting apparatus 10, in accordance with an embodiment of the invention. The control module 104 is disposed inside the lighting apparatus 10 (e.g., within the lighting base 50). The control module 104 comprises a plurality of drivers, such as a lighting driver 104A, a display driver 104C, a power/data input/output (I/O) driver 104D, a wireless DMX module 104G, a memory unit 104F, and a microprocessor 104K.

The lighting driver 104A controls the lighting effects of the lighting elements 60. For example, the lighting driver 104A can selectively turn on or turn off each lighting element 60. The lighting driver 104A can also selectively adjust the color temperature or brightness of each lighting element 60.

The display driver 104C controls the LCD display screen 17 (FIG. 15). The power/data I/O driver 104D controls the power input socket 15A, the power output socket 15B, the data input connector 13A, and the data output connector 13B. The microprocessor 104K is configured to process the data control signals received. The memory unit 104F maintains information such as the DMX address of the lighting apparatus 10.

The wireless DMX module 104G is configured to wirelessly communicate/exchange information (e.g., data control signals) with a wireless DMX controller 400. In one embodiment, the wireless DMX module 104G operates on one or more radio frequencies. The wireless DMX module 104G includes an antenna 104H and a wireless transceiver 104J. The antenna 104H and the transceiver 104J are configured to wirelessly receive radio frequency (RF) signals from, and wirelessly transmit RF signals to, a wireless transceiver 400B of a wireless DMX controller 400. The RF signals received include data control signals such as DMX signals. In another embodiment, the antenna 104H and the transceiver 104J wirelessly exchange information (e.g., data control signals) with a wireless DMX controller 400 using infrared (I/R) waves.

As shown in FIG. 17, a wireless DMX controller 400 comprises an antenna 400A, a wireless transceiver 400B, a controller 400C, a microprocessor 400E, and an A/V interface 400D. The A/V interface 400D of the wireless DMX controller 400 may comprise a graphic display, and alphanumeric and directional keypads that an operator can use to enter input commands. The A/V interface 400D may comprise other types of electronic or manual data input means. The microprocessor 400E of the remote wireless DMX controller 400 is configured to process the input commands entered and generate the appropriate data control signals. The controller 400C of the wireless DMX controller 400 is configured to generate RF signals including the data controls signals generated.

The antenna 400A and the transceiver 400B of the wireless DMX controller 400 are configured to wirelessly communicate/exchange information (e.g., data control signals) with the wireless DMX module 104G of the control module 104. In one embodiment, the antenna 400A and the transceiver 400B operate on one or more radio frequencies. The antenna 400A and the transceiver 400B wirelessly receive RF signals from, and wirelessly transmit RF signals to, the wireless DMX module 104G. In another embodiment, the antenna 400A and the transceiver 400B wirelessly exchange information (e.g., data control signals) with the wireless DMX module 104G using infrared (I/R) waves.

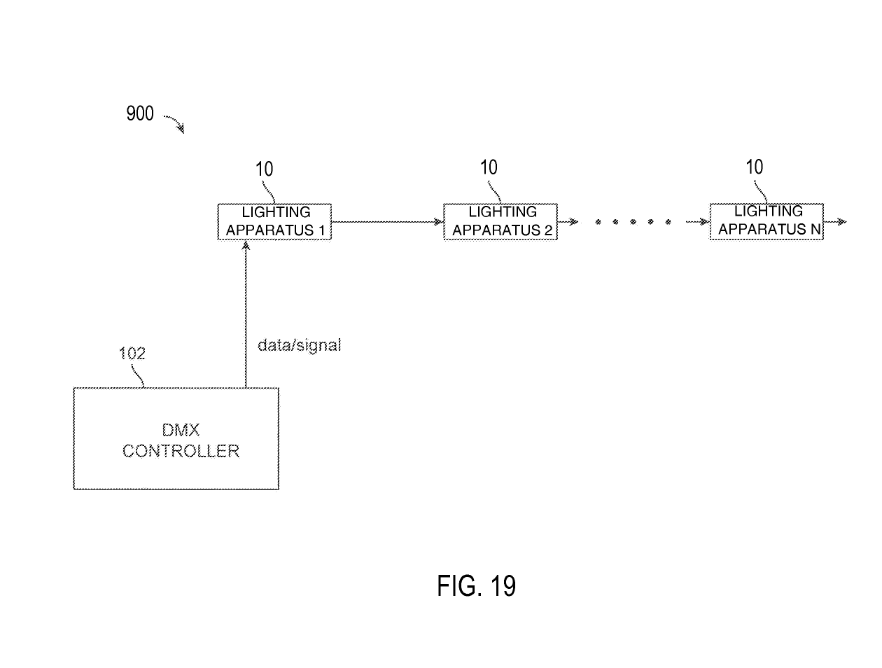

The lighting apparatus 10 may be used as a stand alone, in multiples such as in a parallel lighting circuit 800 (FIG. 18), or linked in a master/slave configuration such as a daisy-chain (i.e., serial) lighting circuit 900 (FIG. 19). In the daisy-chain lighting circuit 900, data control signals (e.g., DMX signals) are sent as serial data that travel from one lighting apparatus 10 to another lighting apparatus 10 via the data connectors 13A, 13B of each lighting apparatus 10. For example, the data input connector 13A receives master/slave DMX signals and the data output connector 13B transmits master/slave DMX signals to the next lighting apparatus 10 in the daisy-chain lighting circuit 900. Each lighting apparatus 10 may have a unique DMX address used to route DMX signals thereto.

FIG. 18 is a block diagram illustrating multiple lighting apparatuses 10 arranged in a parallel lighting circuit 800, in accordance with an embodiment of the invention. The circuit 800 comprises multiple lighting apparatuses 10, such as a first lighting apparatus 10 (LIGHTING APPARATUS 1), a second lighting apparatus 10 (LIGHTING APPARATUS 2), . . . , and an N^{th} lighting apparatus 10 (LIGHTING APPARATUS N). The circuit 800 is controlled by a controller 102, such as a DMX compliant controller. Each lighting apparatus 10 receives data control signals (e.g., DMX signals) from the controller 102 via the data input connector 13A.

Each lighting apparatus 10 in the circuit 800 may also be wirelessly controlled by a wireless controller 400. As described above and illustrated in FIG. 17, a wireless module 104G of each lighting apparatus 10 can wirelessly receive data control signals (e.g., DMX signals) from with a wireless controller 400.

In one embodiment, the controller 102 and/or the wireless controller 400 may selectively send data control signals to a lighting apparatus 10 of the circuit 800. For example, the controller 102 and/or the wireless controller 400 may selectively route a first set of data control signals to a first DMX address corresponding to the first lighting apparatus 10 (LIGHTING APPARATUS 1), and route a different set of data control signals to a second DMX address corresponding to the second lighting apparatus 10 (LIGHTING APPARATUS 2). Therefore, a lighting apparatus 10 of the circuit 800 may be operated differently from other lighting apparatuses 10 of the circuit 800 based on a corresponding set of data control signals from the controller 102 and/or the wireless controller 400.

FIG. 19 is a block diagram illustrating multiple lighting apparatuses 10 linked in a daisy-chain lighting circuit 900, in accordance with an embodiment of the invention. The circuit 900 comprises multiple lighting apparatuses 10, such as a first lighting apparatus 10 (LIGHTING APPARATUS 1), a second lighting apparatus 10 (LIGHTING APPARATUS 2), . . . , and an N^{th} lighting apparatus 10 (LIGHTING APPARATUS N). The circuit 900 is controlled by a controller 102, such as a DMX compliant controller. In the circuit 900, data control signals (e.g., DMX signals) are sent as serial data that travel from one lighting apparatus 10 to another lighting apparatus 10 via the data connectors 13A, 13B of each lighting apparatus 10. Specifically, the data input connector 13A receives master/slave data control signals and the data output connector 13B transmits master/slave data control signals to the next lighting apparatus 10 in the circuit 900. For example, as shown in FIG. 19, a first lighting apparatus 10 (LIGHTING APPARATUS 1) receives data control signals from the controller 102. The first lighting apparatus 10 then transmits data control signals to a second lighting apparatus 10 (LIGHTING APPARATUS 2).

Each lighting apparatus 10 in the circuit 900 may also be wirelessly controlled by a wireless controller 400. As described above and illustrated in FIG. 17, a wireless module 104G of each lighting apparatus 10 can wirelessly receive data control signals (e.g., DMX signals) from with a wireless controller 400.

The present invention has been described in considerable detail with reference to certain preferred versions thereof; however, other versions are possible. The above description is made for the purpose of illustrating the general principles of the present invention and is not meant to limit the inventive concepts claimed herein. Further, particular features described above can be used in combination with other described features in each of the various possible combinations and permutations. Unless otherwise specifically defined herein, all terms should be given their broadest possible interpretation including meanings implied from the specification as well as meanings understood by those skilled in the art and/or as defined in dictionaries, treatises, etc. Therefore, the spirit and scope of the appended claims should not be limited to the description of the preferred versions contained herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A lighting apparatus, comprising:
a lighting base comprising one or more lighting elements;
a control module for controlling said one or more lighting elements;
at least one removable lighting accessory for adjusting light emitted by said one or more lighting elements; and
a mounting system comprising at least one removable mounting member, wherein each mounting member is shaped to engage with and securely mount a lighting accessory to said lighting base.

2. The lighting apparatus of claim 1, wherein said at least one lighting accessory comprises at least one of the following:
a removable lens module for adjusting a beam angle of light emitted by said one or more lighting elements; and
a removable shade module for covering said one or more lighting elements, thereby diffusing light emitted by said one or more lighting elements.

3. The lighting apparatus of claim 1, wherein each mounting member comprises:
a recess shaped for receiving a lighting accessory inserted into said recess; and
a set of mechanical guides shaped to engage and mate with a lighting accessory inserted into said recess.

4. The lighting apparatus of claim 3, wherein said set of mechanical guides comprises one or more locking portions for engaging and mating with a mating portion of said lighting accessory.

5. The lighting apparatus of claim 1, wherein each mounting member comprises:
a set of mechanical guides shaped to interlock with a lighting accessory when said mounting member is inserted into said lighting accessory.

6. The lighting apparatus of claim 5, wherein said set of mechanical guides comprises a plurality of axially extending serrations for engaging and mating with a mating portion of said lighting accessory.

7. The lighting apparatus of claim 2, wherein each mounting member comprises:
a lens retaining ring holder for retaining a removable lens module.

8. The lighting apparatus of claim 1, wherein each mounting member comprises:
one or more magnetic fasteners for magnetically coupling said mounting member to said lighting base.

9. The lighting apparatus of claim 1, wherein:
said control module comprises a plurality of drivers including at least one lighting driver for selectively controlling lighting effects of at least one of said one or more lighting elements.

10. A lighting system, comprising:
multiple lighting apparatuses; and
a controller for providing data control signals to at least one of said multiple lighting apparatuses;
wherein each lighting apparatus comprises:
a lighting base comprising one or more lighting elements;
a control module for controlling said one or more lighting elements; and
a mounting system comprising:
at least one removable lighting accessory for adjusting light emitted by said one or more lighting elements; and
at least one removable mounting member, wherein each mounting member is shaped to engage with and securely mount a lighting accessory to said lighting base.

11. The lighting system of claim 10, wherein each mounting member comprises:
a recess shaped for receiving a lighting accessory inserted into said recess; and
a set of mechanical guides shaped to engage and mate with a lighting accessory inserted into said recess.

12. The lighting system of claim 10, wherein each mounting member comprises:
a set of mechanical guides shaped to interlock with a lighting accessory when said mounting member is inserted into said lighting accessory.

13. The lighting system of claim 10, wherein:
said controller is a wireless controller; and
each lighting apparatus further comprises a wireless module for wirelessly receiving data control signals from said controller.

14. A method, comprising:
mounting at least one removable lighting accessory to a lighting apparatus via a mounting system comprising at least one mounting member; and
adjusting light emitted by one or more lighting elements of said lighting apparatus via said at least one lighting accessory;
wherein each mounting member is shaped to engage with and securely mount a lighting accessory to said lighting apparatus.

15. The method of claim 14, wherein said at least one lighting accessory comprises at least one of the following:
a removable lens module for adjusting a beam angle of light emitted by said one or more lighting elements; and
a removable shade module for covering said one or more lighting elements, thereby diffusing light emitted by said one or more lighting elements.

16. The method of claim 14, wherein each mounting member comprises:
a recess shaped for receiving a lighting accessory inserted into said recess; and
a set of mechanical guides shaped to engage and mate with a lighting accessory inserted into said recess.

17. The method of claim 16, wherein said set of mechanical guides comprises one or more locking portions for engaging and mating with a mating portion of said lighting accessory.

18. The method of claim 14, wherein each mounting member comprises:
a set of mechanical guides shaped to interlock with a lighting accessory when said mounting member is inserted into said lighting accessory.

19. The method of claim 18, wherein said set of mechanical guides comprises a plurality of axially extending serrations for engaging and mating with a mating portion of said lighting accessory.

20. The method of claim 14, comprising:
magnetically coupling a mounting member to said lighting apparatus via one or more magnetic fasteners of said mounting member.
